(19) United States
(12) Patent Application Publication
(10) Pub. No.: US 2009/0327079 A1
(43) Pub. Date: Dec. 31, 2009

(54) SYSTEM AND METHOD FOR A DELIVERY NETWORK ARCHITECTURE

(75) Inventors: Sam Parker, San Francisco, CA (US); Todd Colletti, San Francisco, CA (US); Edmond Meinfelder, San Francisco, CA (US); Christopher Coco, San Francisco, CA (US); John Zorko, San Francisco, CA (US)

Correspondence Address: NIXON PEABODY LLP, 401 Ninth Street, N.W., Suite 900, WASHINGTON, DC, 20004, US

(73) Assignee: CNET NETWORKS, INC., San Francisco, CA (US)

(21) Appl. No.: 12/146,037

(22) Filed: Jun. 25, 2008

(51) Int. Cl. G06F 15/173; G06Q 30/00

(52) U.S. Cl. 705/14.55; 709/226; 709/240; 705/14.66

(57) ABSTRACT

A system and method of managing delivery of data files receives a user request for a data file and determines a user profile and permission level based upon the received user request. The system and method establishes a delivery file path for the requested data file based upon the user profile and permission level, prioritizes delivery of the requested file based upon the user profile and permission level, and delivers the requested file using the established file path and the prioritization determination. A requester may upgrade their user profile and permission level to gain performance resources to access requested files, and the system re-prioritizes deliveries based on the new levels. If sufficient resources are not available to service a user request, the request enters a delivery queue based upon the user profile and permission level. When resources are available, the system delivers the requested file.

### FIELD OF THE INVENTION

The present invention relates to a system and method for delivering data files. More particularly, it relates to delivery network architecture systems and methods for digitally delivering software and media files across networks with improved performance and scalability.

### BACKGROUND OF THE INVENTION

In recent years, networks and interconnectivity of individuals, groups, and organizations has dramatically increased. The Internet connects the world by joining billions of connected users that represent various entities, information, and resources. These connected users form enormous banks of resources, resulting in a world wide web of users. The users store and access data files, documents, and Web pages identified by uniform resource locators (URLs) that can be accessed by other connected nodes on the network.

This vast data store allows previously obscure or unknown information to be disseminated throughout the world. As more users demand access to this information, providers have a more difficult time supplying it as traditional economic issues regarding supply and demand become pervasive. The ever-expanding base of users and the growing number of content suppliers causes increased congestion and strain on the Internet framework and the communication networks that link the parties.

This burgeoning growth places great demands on the infrastructure of the communication networks that provide the physical connections for the World Wide Web. Service providers attempt to provide acceptable performance despite increasing data demand by investing vast sums of money in network infrastructure. To users, acceptable performance means no delay in accessing information, but as network traffic increases, access delays also increase. Network traffic may cause loading delays, and a large number of individual requests may overload a particular server. When part of the network becomes congested with too much traffic, communication over that part of the network becomes unreliable and slow. When too many requests are directed to a single server, the server becomes overloaded, and further delays ensue. These problems can feed upon each other and become mutually problematic as one condition may cause the other, in part because network communication software is often designed to repeat requests that are not serviced promptly. If a server is overloaded, it does not respond to requests quickly, and the requests are resent, thereby increasing network traffic. If a network is overloaded, a request may not reach a server quickly, and a duplicate request may be sent to the server before the server responded to the first request. This further increases the load on the server. Both network overload and server overload lead to delays in retrieving information.

Servers become overloaded a number of reasons. A server storing a small number of data files that have very high access rates can become overloaded. For example, a Web site that uses a server to store a very popular electronic game may be overloaded with the volume of requests for the game. Other servers that store a large number of data files, where each file is accessed at a low access rates, becomes overloaded as it attempts to serve a large number of requests for many different files. For example, a server that is used to store a library of electronic games may serve a vast number of files that are accessed on a regular basis.

Caching can reduce network traffic by storing copies of frequently requested data files throughout the network. This approach spreads the served supply of data files across several servers, and request-routing mechanisms are used to arrange delivery of the content. Demand requests from clients are passed through a cache server that serves the data file if a copy exists on the cache server. When a user requests a Web page, for example, the network redirects the request from the originating Web site server to the cache server that is closest to the requester and delivers the cached content. In this fashion, the client request is satisfied immediately. If the cache server does not have a copy of the requested data file, the cache server requests a copy of the data file from the original Web site. When the cache server receives a copy of the data file from the original Web site, or from a different cache server, it may then satisfy the client's request. Subsequent requests for the same data file may then be satisfied from the cache server, since a copy of the requested data file now exists on the cache server. If the cached copy of the data file is close to the requester on the network, fewer network links need to be traversed to access the data file, so fewer network resources are required to retrieve the data file.

Caching also relieves an overloaded Web site server because some of the requests that would normally be routed to the original Web site are served by the cache server, so fewer requests are made to the original Web site. As more clients share the same cache server, similar network traffic and overloading problems will appear.

Web site and cache servers that provide content over communication networks continue to experience “peak” usage periods after new content is released. During these new-release periods, a large number of users simultaneously attempt to download content from the host or from the cache servers. When the number of client requesters exceeds the ability of the host and the cache servers to service the peak data file requests, the network is unable to provide sufficient resources to service the volume of requests. As the number of requests continues to build and servers exhaust their available resources, additional client requests may be denied. Additionally, new client requests may be served, but the performance for all requesters accessing the host and cache servers may severely degrade and eventually stop out altogether for all clients as resources are completely exhausted. Further, the host and cache servers may crash because key network and computing resources are spent. These server responses are undesirable and unacceptable to requesters. These types of responses impair the ability of any requester to receive content during peak demand periods. Further, as clients continually retry their requests, further strain is put upon the network servers, which can lead to further resource exhaustion.

As server resources are freed, conventional hosts service the first client request that they receive, regardless of how long the requester was attempting to access the host or the cache servers. Resource allocation becomes random, and requesters have no guarantee of a time frame in which the host or cache server will service their request. In fact, clients accessing the host or cache server for the first time may receive their requested data files before clients that have been requesting service for a longer period of time. This random service level and quality of service leads to user dissatisfaction.

Conventional file transfer systems and delivery architectures provide no means to resume downloads after a loss of connection or upon freeing additional resources. This is very inconvenient for data file recipients and requesters that must restart large downloads. As the size of the file transfers increases, the ability for systems to handle large files becomes problematic, and the inability of users to receive large file transfers is exacerbated.

Additionally, current file transfer systems do not schedule the file transfers efficiently to take full advantage of available system resources and to reduce overhead costs while providing a satisfactory level of customer service. Satisfactory levels of scalability to meet sudden increases in demand are not implemented efficiently in conventional file transfer systems.

What is needed is a delivery network architecture system and a method for delivering data files across networks that improves performance and scalability without exhausting network resources. The system and method should address resource limitations and judiciously assign additional resources, while providing an effective means with which to recover from delivery interruptions.

### SUMMARY OF THE INVENTION

The present invention relates to systems and methods for delivering data files that provide a responsive, resumable delivery experience for subscribers, registered users, and unregistered users. The system of the present invention provides a delivery network architecture and a method for digitally delivering software and media files with improved performance and scalability. The system and method of the present invention provides users with timely and convenient access to data files and content.

The system and method of managing delivery of data files receives a user request for a data file and determines a user profile and permission level based upon the received user request. The system and method establishes a delivery file path for the requested data file based upon the user profile and permission level, prioritizes delivery of the requested file based upon the user profile and permission level, and delivers the requested file using the established file path and the prioritization determination.

A requester may upgrade their user profile and permission level to gain performance resources to access requested files, and the system re-prioritizes deliveries based on the new levels. If sufficient resources are not available to service a user request, the request enters a delivery queue based upon the user profile and permission level. When resources are available, the system delivers the requested file. Similarly, a requester may upgrade their user profile and permission level to improve their position in the queue, or to otherwise speed up delivery of the requested file. Available data files, the requested file, as well as the status of the delivery, including the requester's position in a queue, is displayed to the requester. Additionally, advertisements and up-sell promotions may also be displayed to the user based upon the user's profile and permission level.

The system and method of the present invention also manages delivery of data files by connecting to multiple hosts to access and receive requested data files in chunks, where, if the delivery of the chunks of the data file is interrupted, the delivery resumes at the point the interruption occurred, thereby eliminating the need to re-deliver the entire data file. Similarly, additional resources are made available, including additional bandwidth resources, to increase the speed of the delivery of the requested data file based upon the user profile and permission level of the user.

Available resources may be scaled based upon demand predictions, including previous demand, time of day, day of week, week of year, popularity of the requested file, subject matter of the requested file, geographic location from which the request is initiated, demographic data of anticipated users, and the like. Delivery statistics, including attempted unsuccessful deliveries, are collected to assess and analyze performance and business metrics.

The system for managing delivery of data files includes a delivery network architecture (DNA) foundation module and a delivery network architecture (DNA) helper module. The delivery network architecture foundation module monitors infrastructure load and availability and provides delivery location options based on a user profile and permission level. To evaluate delivery options, the delivery network architecture foundation module collects and maintains load, usage, and performance data from the delivery infrastructure, including content delivery networks.

The delivery network architecture foundation module may be a server that includes hardware or software modules to perform processes in accordance with methods of the present invention. Similarly, delivery architecture foundation module may be a discrete module within a server. Delivery network architecture foundation module may include a DNA broker module to monitor, negotiate, and allocate network resources to serve users. DNA broker may include a receiving module that receives a user request for a data file, a determination module that determines a user profile based upon the received user request, and a pathmaker module that establishes a file path for delivery of the requested data file based upon the user profile. The system also may include a scheduler module that prioritizes delivery of the requested data file based upon the user profile and a delivery module that delivers the requested data file using the established file path and the prioritization determination. The system also may include a delivery network architecture database that stores the requested data file for delivery to the user by the delivery network architecture server as well as a display module that displays a list of available data files that a user may request for delivery.

The computer system for managing delivery of data files of the present invention further may include a permission slip module that confirms the permission level of the user based upon the determined user profile, a field trip module that establishes the file path for delivery of the requested data file based upon the confirmed permission level of the user, and a rescheduling module that re-prioritizes delivery of the requested data file based upon the confirmed permission level of the user.

Additionally, the system of the present invention may include a sponsor module that determines if a sponsored upgrade to the user profile or permission level applies based upon the determined user profile. The system also may include an upgrade module that upgrades the permission level based on the sponsorship upgrade, an express lane module that establishes an upgraded file path for delivery of the requested data file based upon the upgraded permission level of the user, and a preferred rescheduling module that re-prioritizes delivery of the requested data file based upon the upgraded permission level of the user. Likewise, the computer system for managing delivery of data files of the present invention further may include an advertising module that displays at least one of advertising messages or up-sell promotions to the user based upon the confirmed permission level of the user.

In addition, the computer system for managing delivery of data files also may include a resource manager module that determines if the established file path has sufficient resources to service the user request. If sufficient resources are available to service the user request, the resource manager module forwards the requested data file to the delivery module for delivery to the user. However, if sufficient resources are not available to service the user request, the resource manager module enters the user request into a queuing module, where additional resources are made available to the queuing module based upon the permission level of the user. The DNA resource manager allocates bandwidth for clear content delivery requests based upon permission levels. The additional resources that are made available to the queuing module for delivery of the data file to service the user request are prioritized based upon the confirmed permission level of the user.

To facilitate delivery of the data file, the system of the present invention may include multiple servers or multiple hosts, so if sufficient resources are not immediately available to service the user request, the additional resources made available to the queuing module include the multiple hosts to access and provide the requested data file in chunks. Similarly, if sufficient resources are not available to service the user request, additional bandwidth resources are made available to the queuing module to increase the speed of the delivery of the requested data file. The resources may be scaled based upon predictions related to demand for the requested data file and based upon the quality of service level required for each user class.

Additionally, the system of the present invention may include a delivery network architecture statistics collector that collects and reports statistics from users regarding the delivery of data files for performance analysis and business reporting. The statistics may include the number of downloads, the average download times by user class level, permission level and quality of service level as well as the bandwidth by permission level, the number of connection failures, and the queue lengths by permission level.

Additionally, the delivery network architecture foundation module may include a delivery network architecture metadata interface module to abstract sources for file download locations as well as a content database interface that manages connections and queries to the delivery network architecture metadata interface in response to a query for a list of file download locations. Further, the delivery network architecture foundation module may include a user registration service interface that abstracts and centralizes user registration service comparisons to validate user profiles.

The system of the present invention also may include a delivery network helper module that is a portable client that may be installed on users' systems to provide intelligence to help manage quality of service, increase delivery reliability, and return user-specific statistics for performance analysis and business reporting. The delivery network helper module is portable to any browser, operating system, and device platform and may be integrated into applications produced by third parties.

The delivery network architecture helper module initiates delivery of the requested data file and provides status of the delivery. Further, the delivery network architecture helper module includes a client management library to store and assemble the requested data file on a client file system. The stored and assembled data file may be delivered and stored in file chunks as the requested data file is delivered to the client. Additionally, the stored and assembled data file chunks may be segmented using range retrieval requests where the range retrieval requests resume delivery of the chunks of the segmented data file if the delivery is interrupted. Likewise, the range retrieval request discards the chunk of the segmented data file that was being delivered when the delivery was interrupted, retains previously delivered chunks, and resumes delivery of remaining chunks of the segmented data file thereby eliminating the need to re-deliver the entire data file when delivery is interrupted.

The system and method of the present invention extends the functionality of content delivery networks to cooperatively and transparently deliver data files to end users by employing the delivery network architecture of the present invention to satisfy requests for delivery of data files by optimizing delivery processes, scalability, and infrastructure. The present invention provides a system and method of providing tiered levels of digital delivery service to user communities at specific price points.

These and other advantages, aspects, and features of the present invention will become more apparent from the following detailed description of embodiments and implementations of the present invention when viewed in conjunction with the accompanying drawings. The present invention is also capable of other embodiments and different embodiments, and details can be modified in various respects without departing from the spirit and scope of the present invention. Accordingly, the drawings and descriptions below are to be regarded as illustrative in nature, and not as restrictive.

### BRIEF DESCRIPTION OF THE DRAWINGS

The accompanying drawings illustrate an embodiment of the invention and depict the above-mentioned and other features of this invention and the manner of attaining them. In the drawings:

FIG. 1 illustrates an exemplary computer system and network in accordance with an embodiment of the present invention.

FIG. 2 illustrates an exemplary delivery network architecture broker module in accordance with the present invention.

FIG. 3 illustrates an exemplary client in accordance with the present invention.

FIGS. 4A-4D show a flow chart illustrating methods in accordance with the present invention for delivering data files and content to a client using a system in accordance with the present invention.

### DETAILED DESCRIPTION OF THE INVENTION

The following detailed description of the invention refers to the accompanying drawings and to certain preferred embodiments, but the detailed description of the invention does not limit the invention. The scope of the invention is defined by the appended claims and equivalents as it will be apparent to those of skill in the art that various features, variations, and modifications can be included or excluded based upon the requirements of a particular use.

As illustrated in the discussion below, the present invention provides a system and method for a delivery network architecture that avoids the disadvantages of prior systems by allowing easy and rapid delivery of software, data, media files, and information across networks. The delivery mechanism and network architecture of the present invention enables a new business model, including the digital delivery of soft goods and one-time paid services.

The present invention extends the functionality of current delivery networks and techniques to provide a delivery network architecture to enable data transfers of software, media, and information files with improved performance and scalability. The present invention may be used to transfer software files (“files”) but is intended to cover additional items such as games, music, computer programs, multimedia content, RSS feeds, and other goods and services that may exist in a less-tangible form than a concrete product. One of ordinary skill in the art would understand that the term “files” should also be extended to encompass these other goods and services as well. For brevity, the terms “files” and “content” as used in conjunction with the present invention may be used interchangeably and should be understood to cover these other items and other similar goods and services as well.

Customers are willing to pay for timely and convenient access to content, including games, movies, music, “files”, “content”, and the like. To ensure that a customer's access to content is convenient and timely, the system and method of the present invention provides means to rapidly and easily deliver content and to resume transfers or downloads after loss of connection, or upon a user-initiated pause in the file transfer. With the system and method of the present invention, there is no need to re-start transfers from the beginning. Instead, upon re-start, the file transfer picks up from where it left off. Customers will typically pay correspondingly more for a perceived corresponding increase in a quality of service. The system and method of the present invention creates a hierarchy of user classes to segment different service levels. As such, users may choose the level of service they desire and pay accordingly. In this fashion, the system and method of the present invention has the ability to create different levels of service and reach a broader customer and user base. Users accessing a provider for specific event-driven or otherwise timely content may be willing to pay a premium to receive the content quickly and conveniently. Further, the different service levels provide a mechanism to schedule system resources intelligently to reduce overhead costs while supporting the commitment to customers' desired quality of service.

The present invention provides a system and method of providing tiered levels of digital delivery service to user communities at specific price points. The architecture of the present invention integrates third-party content delivery networks (CDNs) to guarantee quality of service levels during peak user capacity.

The system and method of the present invention includes a file download and transfer system, including server and client components. The system and method of the present invention enables seamless transfers from provider Web sites where clients may pause a transfer and resume the transfer at their convenience. Similarly, the system and method of the present invention enables transfer recovery after download interruptions or connection losses. The system and method of the present invention further provides differentiation of services based upon a hierarchy of user classes. For example, the user classes may include different levels of service by limiting the number of concurrent downloads, limiting the number of files that may be in a download queue, and limiting the number of file chunks of the same file that can be downloaded simultaneously based upon the user class. Other methods of establishing different levels of service may also be used. By efficiently classifying users, the system and method of the present invention effectively uses system resources while maintaining a scalable system that is able to meet sudden increases in user demand.

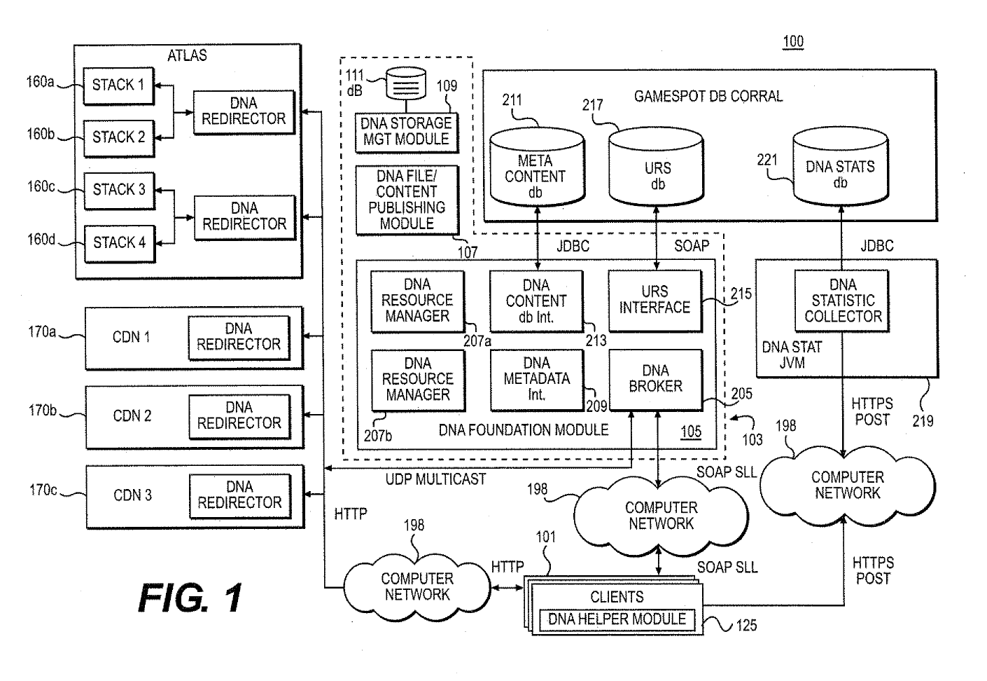

FIG. 1 illustrates an exemplary computer system 100 in which processes and methods in accordance with the present invention may be performed. As shown in FIG. 1, system 100 comprises a client-side user 101 as well as a server 103. A user 101 may be an individual, group, client, server, and the like. Users, such as client-side user 101 may access delivery network architecture (DNA) server 103 performing a method of the present invention. DNA server 103 may include DNA foundation module 105, DNA file/content publishing module 107, and DNA storage management module 109. DNA storage management module may include a file storage database 111. File storage database 111 may be integral to DNA server 103, or it may be located separately from DNA server 103. Additionally, for clarity and brevity, a single client-side user 101 is shown, but it should be understood that any number of client-side users may use system 100 with which to access DNA server 103. Database 111 may also be a network of databases as well, connected to DNA server 103 or accessible by DNA server 103. Likewise, it should also be understood that any number of DNA servers may be used by the system. Multiple DNA servers may be segregated by geographic location, by the type or number of files that they offer, or by any number of criteria commonly used to configure server farms, Web farms, or otherwise distribute computing resources and workloads between multiple computers and multiple modules. Multiple DNA servers provide alternative points from which files and content may be provided. Multiple DNA servers also provide authentication and service points where a user may schedule chunking downloads and take advantage of multiple delivery servers, where each server supplies pieces of the content or file to the user, reducing the cost and burden on any given individual source, providing redundancy against system problems, reducing dependence on a single distributor, and improving download transmission speed.

For clarity and brevity, a single DNA server 103 comprising DNA foundation module 105, DNA file/content publishing module 107, DNA storage management module 109, and DNA database 111 is shown. It should also be understood that a user 101 and a DNA server 103 may be substituted for one another. That is, any user 101 may access files housed and stored by another user. DNA server 103 is illustrated as component modules 105, 107, 109, 111 merely to show a preferred embodiment and a preferred configuration. The files can be requested, accessed, and transferred in a distributed environment, such as servers on the World Wide Web.

Users 101 may access DNA server 103 through any computer network 198 including the Internet, telecommunications networks in any suitable form, local area networks, wide area networks, wireless communications networks, cellular communications networks, G3 communications networks, Public Switched Telephone Networks (PSTNs), Packet Data Networks (PDNs), intranets, or any combination of these networks or any group of two or more computers linked together with the ability to communicate with each other.

Client Side

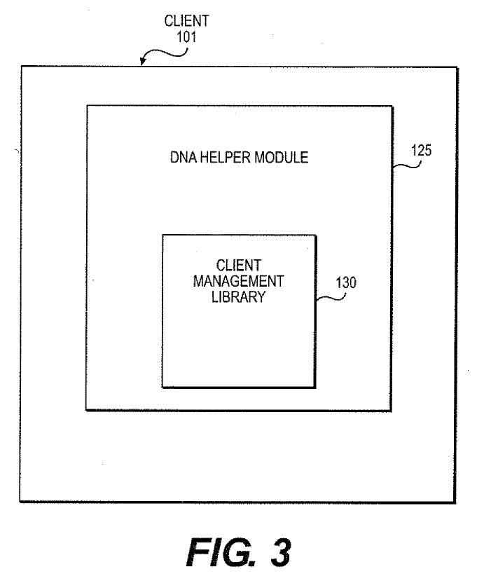

As also shown in FIG. 3, client-side user 101 includes a DNA helper module 125. DNA Helper module 125 may be a portable client that installs on the client-side user 101 as a system service, as a daemon, or the like. DNA helper module 125 provides a graphical user interface (GUI) to communicate and interact with DNA server 103 and to provide progress and status of file transfers and downloads. The user may customize and filter views. For example, DNA helper module 125 may be configured to provide a GUI to display the file name of the download and the percent downloaded as well as to provide abort control, pause control, and resume control of the downloads. DNA helper module 125 may use an identification (token) to trigger an event to initiate each new download. In turn, a new download entry is created in the displayed list. Periodically, updates are sent from DNA Server 103 to the DNA helper module 125 indicating the percentage downloaded for each file. When a user initiates a control function to manage the download, such as abort, pause, or resume, DNA helper module 125 calls a corresponding function with the identification (token). The download management functionality may also be stored in a client management library 130 or other reusable medium. In this fashion, the functionality of the client may be reused in other applications. Also, by separating the interface from the download functionality, the operations may operate independently from each other.

DNA helper module 125 may be portable to any browser, operating system, or device platform, and may be integrated into applications produced by third parties. DNA foundation module 105 is extensible to account for changing infrastructure deployments, but does not deploy at third-party sites. DNA store module 135 may be utilized to capitalize upon co-branding and partnering opportunities, such as showing advertisements based upon a function of the content or files that a user is accessing.

DNA helper module 125 provides intelligence to manage the user quality-of-service (QOS), increase delivery reliability, and return user-specific statistics for file transfer performance analysis and business reporting. The statistics may include, for example, where the download was performed, the size and time elapsed for the download, connection failures, and other information describing the manner in which the file transfer was performed. The user experience may be Web-native or application-native by interfacing with this service locally, as a local Web service, for example.

DNA helper module 125 may include peer-to-peer (P2P) features. DNA helper module 125 receives data in chunks so it can manage data and file streams from multiple delivery locations and perform error-checking. The chunking method may employ multiple delivery locations, where each recipient supplies pieces of the data, file, or content to newer recipients, reducing the cost and burden on any given individual source, providing redundancy against system problems, and reducing dependence on the original distributor. The file chunks may be stored on a client file system before assembling the complete file. DNA helper module 125 may be configured to limit the number of concurrent downloads by user class, and it may also be set up to limit the number of files in its queue for download by user class. Additionally, users may be willing to share their upload bandwidth in a P2P environment in exchange for an increased level of service to access additional content. Increased levels of service may also be available to those users who view content provided by partner advertisers or other commercial content suppliers. Conversely, DNA helper module 125 may preempt advertisements based upon the user class and the type of transaction, file transfer, or download performed. DNA helper module 125 may also combine tracking logic at a server level to advertise and connect peers in a proprietary way. Additionally, users 101 may pause and restart deliveries, perform multiple simultaneous downloads, and queue downloads for future delivery using DNA helper module 125.

The system and method of the present invention provides the means and techniques to resume downloads at the point which the transfer stopped. A transfer may stop by losing a network connection or otherwise interrupting the transfer. With the system and method of the present invention, there is no need to restart the download from the beginning. The ability to pick up where the transfer left off provides great time savings and convenience to users. The system and method of the present invention uses range-retrieval requests on the HTTP GET command to accomplish the restarts. HTTP retrieval requests using conditional or unconditional GET methods may request one or more sub-ranges of the entity, instead of the entire entity, using the Range request header, which applies to the entity returned as the result of the request. Clients 101 downloads files by chunks, and if the client 101 aborts a download or suffers a connection loss in the midst of a chunk being transferred, the client DNA helper module 125 discards that partial chunk, but retains all previously downloaded chunks. Therefore, when client 101 resumes or receives connectivity, the client helper module 125 begins to download only the missing chunks, thereby eliminating the need to download the file from the beginning.

Since each user class has a limit for the number of concurrent file downloads, DNA helper module 125 also includes interface control to show entries in order. For example, the most recent entries may be displayed at the bottom and the first entries may be shown at the top of a display screen or GUI component. DNA helper module 125 may draw queued entries to indicate that these entries are not yet active, and that the only option users have with regard to these entries is aborting the scheduled download. Further, the queued and in-progress downloads may be stored on a user's file system or storage device.

Server Side

On the server 103 side, DNA foundation module 105 may be a brokering module. As a brokering module, DNA foundation module 105 monitors infrastructure load and availability and provides the DNA helper module 125 with delivery location options appropriate to a given user based on a user class at a given moment. The user classes may include “unregistered”, “registered”, “premium”, and “total access,” and the delivery location options may include uniform resource locators (URLs). To make its decisions, DNA foundation module 105 collects and maintains load, usage, and performance data from DNA helper module 125 and from the delivery infrastructure, including internal delivery resources, such as Atlas stacks 160a, 160b, 160c, 160d, and external content delivery networks (CDNs), such as CDN1 170a, CDN2 170b, CDN3 170c. The DNA foundation module 105 manages access to the infrastructure based on user class priorities and cost constraints. DNA foundation module 105 references current user class information that is stored in a User Registration System (URS) database 217. URS database 217 stores registration information regarding clients 101. URS database 217 may be accessed by URS interface module 215 in the DNA foundation module 105. URS interface module 215 abstracts and centralizes registration interactions. The DNA broker module 205 and DNA resource manager module 207 use URS interface module 215 to validate the identity of client users and states to which class the client user belongs. The registration information is accessed by URS interface module 215 and passed to DNA broker module 205. The URS database 217 may then be accessed via SOAP calls or by other protocols and messaging frameworks for exchanging XML-based messages or other formatted messages over computer networks. By storing current user class information in URS database 217, last minute user subscription changes are taken into account when providing delivery location options to a given user based on the user class.

For example, validation may be performed by the DNA client 101 sending an authentication cookie from a previous visit to the foundation module 105 and DNA broker module 205. DNA broker module 205 then passes the authentication cookie to URS interface 215, which interrogates URS database 217 to perform the validation. Additionally, DNA client 101 may prompt the user for an identification (token) and a password, which may then be used by DNA broker module 205, URS interface 215, and URS database 217 to validate the user. This alternative requires intervention by the user, but it removes the dependency of the Web site and the recurrent cookie authentication. This alternative may be preferable if the client 101 is restarting a download without the browser or without logging in to the content-providing Web site.

The system 100 of the present invention may collect statistics regarding the number of downloads from clients, client exceptions, download requests, and downloads performed from the various locations. For example DNA statistic collector module 219 may be used to collect and display client statistics. DNA statistics collector module 219 may be housed separately from DNA server 103 (as shown in FIG. 1) or may be integral to DNA Server 103. The DNA statistic collector module 219 may collect and display statistics for each file, including the number of downloads, the average download times by user class, and the like. Additionally, for each content file co-location, DNA statistic collector module 219 may collect statistics including the bandwidth used by user class, the number of connection failures, the number of downloads and average download time, the queue length by user class, and other content and location-related information. At the successful completion of a download, clients 101 will report to DNA statistic collector module 219 where each chunk of a file was downloaded, the time taken to download each chunk, the number of connection failures for each download location, the elapsed time to download the entire file, and other statistical information. By monitoring, reporting, and acting upon usage information, the system 100 of the present invention balances infrastructure usage and costs while preserving positive user experiences and quality of service. Reports describe to what extent users are receiving the quality of service they expect as well as the manner in which users are leveraging the services. To act upon the collected usage information, DNA foundation module 105 allocates bandwidth, manages user queues and wait states, and balances loads based upon user class. For example, the DNA foundation module 105 may allocate bandwidth by user class where users with total access are allocated 12.5% of the total bandwidth, users with premium access are allocated 12.5%, users with registered access are allocated 56.25% of the total bandwidth, and users with unregistered access are allocated 18.75%.

If the system resources that support the file transfers and downloads are completely committed when an additional user requests a download, a servicing strategy to service the additional user's request may be implemented by the DNA foundation module 105. For example, if ten users are waiting to access a resource such as a Web server from which clients are downloading content or files, when an eleventh user requests that same resource, the DNA foundation module 105 may implement a service strategy such as satisfying the ten previous users before handling the eleventh user. Of course, other service strategies may also be employed to determine how to service users when all resources are temporarily committed. For example, if the eleventh user was previously delayed service, the service strategy may dictate that this user receive the content prior to some of the other users that have not been previously delayed.

Usage monitoring and reporting may be performed at the infrastructure level to predict trends, anticipate problems, and monitor and predict costs of usage and costs of operation. Additionally, users performing discrete payment transactions, where the user is not a subscriber, but rather is making a single transaction, may be separately classified and afforded priority when requesting content and files. Additional service strategies may be employed, including for example, limiting availability of certain content or files to specific user classes. For example, high resolution movies and game guides may be limited to users with total access and those performing discrete payment transactions.

As shown in FIG. 1, DNA foundation module 105 includes modules 205, 207a, 207b, 209, 213, 215, 107, 109, 111. DNA broker 205 keeps track of which DNA resource managers 207a, 207b (referred to collectively as reference numeral 207) are available to serve new users. Before users begin to download content, the users contact DNA broker 205 with an identifier to receive a list of download points and authorization. The authorization may be encrypted or otherwise protected to prevent unauthorized usage. For example, an encrypted authorization may use 128-bit encryption, which the client 101 never decrypts and passes it to a DNA resource manager 207 as an authorization token. The authorization may contain the item requested for download, the customer identification, the customer user class, and a time indicator, such as a token referencing Coordinated Universal Time (UTC) stating when the client authorization expires. A DNA resource manager 207 decrypts the authorization and accepts or rejects the authorization, depending upon the authorization contents. DNA resource manager 207 then provides a list of download points if the authorization is accepted and streams the request to the client 101. If the token is invalid, server 103 indicates to the client that the authorization failed. System 100 may employ Java Management Extensions (JMX) or other tools for managing and monitoring applications, system objects, devices, and service oriented networks. Likewise, system 100 may use Java Messaging Service (JMS) or other application programming interfaces for sending messages between two or more brokers.

The delivery network architecture foundation module 105 may be a server that includes hardware or software modules to perform processes in accordance with methods of the present invention. Similarly, delivery architecture foundation module 105 may be a discrete module within a server. Delivery network architecture foundation module 105 may include a DNA broker module 205 to monitor, negotiate, and allocate network resources to serve user clients 101.

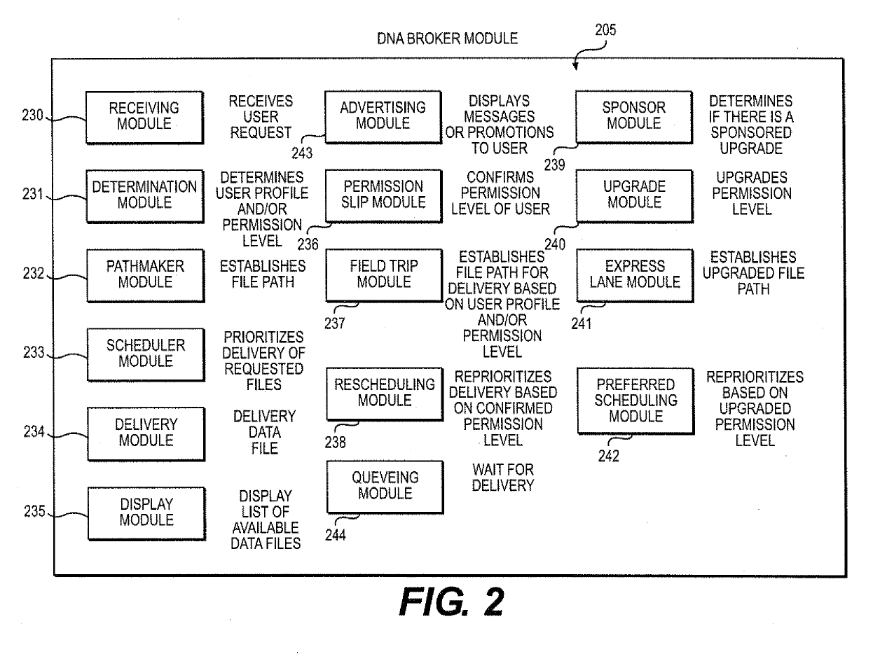

As further shown in FIG. 2, DNA broker module 205 may include a receiving module 230 that receives a user request for a data file, a determination module 231 that determines a user profile based upon the received user request, and a pathmaker module 232 that establishes a file path for delivery of the requested data file based upon the user profile. The system 100 also may include a scheduler module 233 that prioritizes delivery of the requested data file based upon the user profile and a delivery module 234 that delivers the requested data file using the established file path and the prioritization determination. The system 100 also may include a delivery network architecture database 111 that stores the requested data file for delivery to the user by the delivery network architecture server 103 as well as a display module 235 that displays a list of available data files that a user may request for delivery.

The computer system 100 for managing delivery of data files of the present invention further may include a permission slip module 236 that confirms the permission level of the user client 101 based upon the determined user profile, a field trip module 237 that establishes the file path for delivery of the requested data file based upon the confirmed permission level of the user, and a rescheduling module 238 that re-prioritizes delivery of the requested data file based upon the confirmed permission level of the user.

Additionally, the system 100 of the present invention may include a sponsor module 239 that determines if a sponsored upgrade to the user profile or permission level applies based upon the determined user profile. The system 100 also may include an upgrade module 240 that upgrades the permission level based on the sponsorship upgrade, an express lane module 241 that establishes an upgraded file path for delivery of the requested data file based upon the upgraded permission level of the user, and a preferred rescheduling module 242 that re-prioritizes delivery of the requested data file based upon the upgraded permission level of the user. Likewise, the computer system 100 for managing delivery of data files of the present invention further may include an advertising module 243 that displays at least one of advertising messages or up-sell promotions to the user based upon the confirmed permission level of the user.

In addition, the computer system 100 for managing delivery of data files also may include a resource manager module 207 that determines if the established file path has sufficient resources to service the user request. If sufficient resources are available to service the user request, the resource manager module 207 forwards the requested data file to the delivery module 234 for delivery to the user. However, if sufficient resources are not available to service the user request, the resource manager module 207 enters the user request into a queuing module 244, where additional resources are made available to the queuing module based upon the permission level of the user. The DNA resource manager 207 allocates bandwidth for clear content delivery requests based upon permission levels. The additional resources that are made available to the queuing module 244 for delivery of the data file to service the user request are prioritized based upon the confirmed permission level of the user.

DNA resource managers 207a, 207b (referred to collectively as reference numeral 207) manage the bandwidth for each co-location facility allocating bandwidth to the user classes. If the maximum bandwidth for a user class has been allocated, DNA resource manager 207 queues the client 101. DNA resource manager 207 segments bandwidth at each co-location, ensuring the ratios of bandwidth available match the population of users in the respective classes and that the bandwidth available for each user class matches the intended quality of service for that class. When bandwidth at a co-location reaches its limit, subsequent download requests are queued. Each user class has a total bandwidth limit, which the DNA resource manager 207 will not exceed. The combined bandwidth of all user classes caps the capabilities of the system at any point in time.

DNA broker 205 decides what download locations to serve DNA clients 101 based on the user class. Total Access members may access Atlas download stacks 160a, 160b, 160c, 160d as well as content data networks (CDNs) 170a, 170b, 170c, 170d. Content is duplicated on CDN nodes 170a, 170b, 170c, 170d deployed in multiple locations, often over multiple backbones. These CDN nodes 170a, 170b, 170c, 170d cooperate with each other to satisfy requests for content by end users, transparently moving content to optimize the delivery process. Commercial CDN nodes provide optimization that can take the form of reducing bandwidth costs, improving end-user performance, or increasing global availability of content. CDNs used in accordance with the present invention are effective in speeding the delivery of content of Web sites with high traffic and extending the global reach of Web sites. The closer a CDN server is to a user geographically, the faster the content will be delivered to the user. CDNs also provide protection from large surges in traffic by optimally routing content requests to CDN servers with capacity to handle the content requests. Requests for content may be optimally directed to CDN nodes based on traffic volume, geographic location, and other criteria. The system and method of the present invention may then choose the CDN node that is best suited for serving content to the user based upon the determined criteria.

Clients 101 that pay a per download fee automatically use the CDN 170a, 170b, 170c, 170d for fastest access, while other clients 101 compete for the pre-allocated bandwidth available on the Atlas download stacks 160a, 160b, 160c, 160d. The Atlas download stacks 160 may include netscalers or other front end servers that cache a portion, such as 140 GB, of the most active files as well as a back end archive server attached to a larger, for example 6 TB, data store. The netscaler round robin calls to aliases of the Atlas stacks and provides them to the front end servers that contain identical caches of the most popular files. If the requested file is in the cache, it is returned at that point. If it is not in the cache, a call is made to the back end data store and the caches statistics are updated. Security is provided by an authentication check using a cookie stored on the client machine. The Atlas URL link may be of the form [server name] [disk name] [file path] [file name]. By offering different levels of service via different servers, disks, and file paths, the system and method of the present invention may serve different classes of users with different qualities of service.

The system 100 scales download service to meet sudden increases in client demands. This scaling may be performed in a number of different ways. For example, clients 101 attempt to download files and content from wherever they can. If one download facility is queuing users, clients 101 will attempt to download their file chunks from other locations. User demand throughout the system 100 will be balanced. By accessing CDN 170a, 170b, 170c, 170d, a reserve pool of bandwidth is also available to classes of users. Further, a swarm download model may be employed where clients 101 may serve each other. As one client 101 downloads a particular file chunk, DNA helper module 125 reports the download to DNA broker 205, which then makes that file chunk available to other clients for download.

DNA metadata interface module 209 provides service to the system 100 by abstracting the source for file download locations. The file locations may be resident in database 111, or may be located at different locations. The DNA metadata interface module 209 receives an identification from DNA helper module 125 on the client 101 side of the network 198 and responds with a list of file locations indicating where the client 101 can download the content files. If no download locations exist for the identification, an empty list is returned. While the download locations for the content files exist in database 111, the list of download locations corresponding to the identification may exist in a separate location, an alternative storage device, a separate database, such as meta content database 211, and the like. The list of file locations may be acquired by DNA metadata interface module 209 via a DNA content database interface module 213.

DNA content database interface 213 manages connectivity and queries for download locations. The connectivity may be via an application program interface (API), such as Java Database Connectivity (JDBC), or a similar API. DNA content database interface 213 defines and manages the manner in which a client 101 may access a database, including DNA database 111, Atlas stacks 160a, 160b, 160c, 160d, and content delivery networks (CDNs) 170a, 170b, 170c. DNA content database interface 213 provides methods for querying and updating data in the databases.

The content database interface 213 receives the query for a list of file locations from a DNA broker 205 via DNA metadata interface module 209. The content database interface 213 queries the meta content database 211 using the API above to receive the location information. If no download locations exist for the identification, an empty list is returned. As indicated above, while the download locations for the content files exist in database 111, the list of download locations corresponding to the identification may exist in a separate location, an alternative storage device, a separate database, such as meta content database 211, and the like. The list of file locations may be acquired by DNA content database interface module 213 and passed to DNA metadata interface module 209. The database 211 may then be accessed via JDBC calls or by other mechanisms used by application programs to request service from the operating system.

The related server 103 modules may include file/content publishing module 107 that may be used to add content to databases and storage libraries as well as storage management module 109, which may be used to manage the use of storage infrastructure internally and at external CDNs 170a, 170b, 170c. The infrastructure of system 100 and server 103 also prevents deep linking by foreclosing non-approved users from connecting to the system 100.

In addition to the server modules 105, 107, 109, 111, DNA store module 135 enables additional monetization strategies by integrating new and existing e-commerce and digital rights management components. DNA store module 135 may be housed separately from DNA server 103 (as shown in FIG. 1) or may be integral to DNA server 103. DNA store module 135 delivers files, soft goods, and products to user clients 101. For example, DNA store module 135 may deliver full-game sales, movie rentals, movie sales, and internally or externally-produced content such as game guides and the like. DNA store module 135 includes discrete purchase capabilities, support for multiple content types and digital rights management integrated into the available files. Additionally, DNA store module 135 may integrate these features into partner Web sites via additional DNA helper modules.

As illustrated in FIG. 1, computer network 198 may be the Internet where clients 101 are nodes on the network 198 as is DNA server 103. User clients 101 and DNA server 103 may be any suitable device capable of providing a document to another device. For example these devices may be any suitable servers, workstations, PCs, laptop computers, PDAs, Internet appliances, handheld devices, cellular telephones, wireless devices, other devices, and the like, capable of performing the processes of the exemplary embodiments of FIGS. 1-4. The devices and subsystems of the exemplary embodiments of FIGS. 1-4 can communicate with each other using any suitable protocol and can be implemented using one or more programmed computer systems or devices. In general, these devices may be any type of computing platform connected to a network and interacting with application programs.

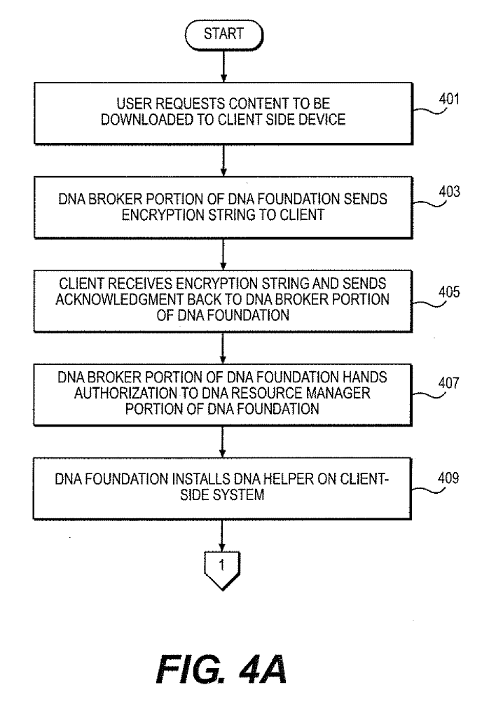

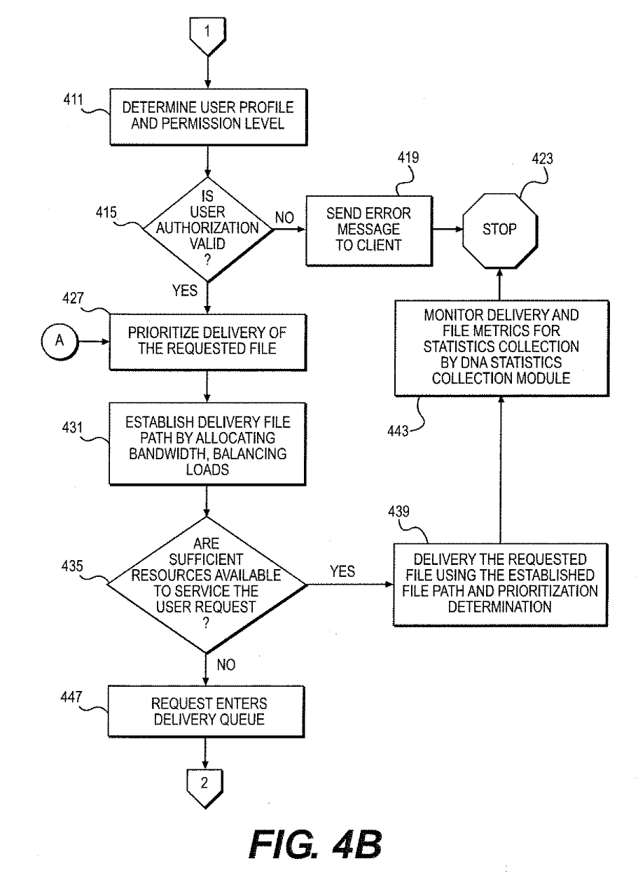

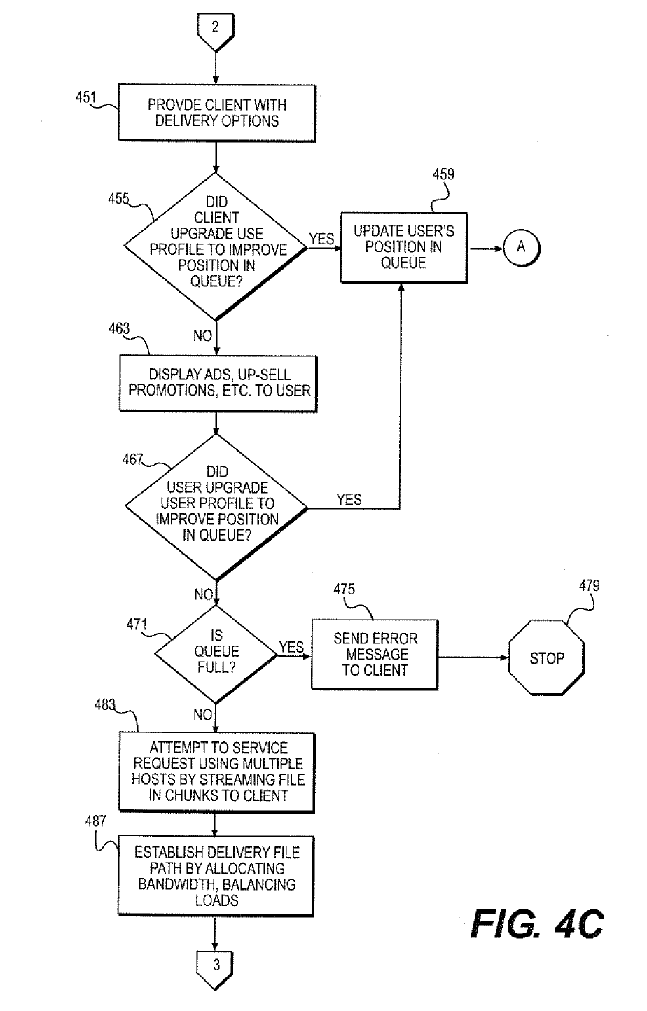

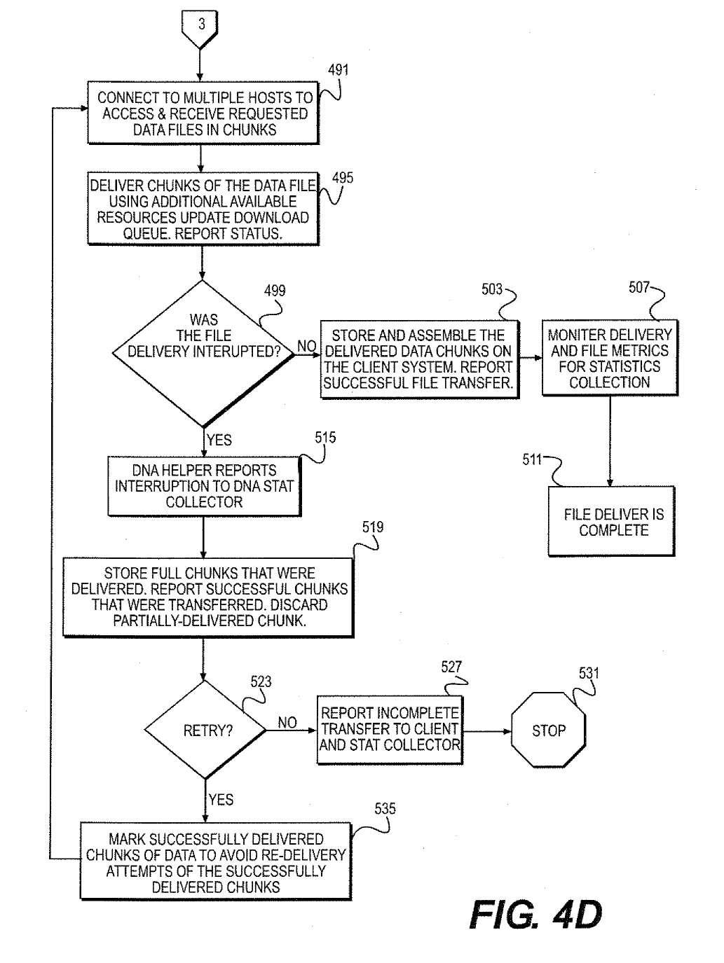

Likewise, while component modules 105, 107, 109, 111 are illustrated in FIG. 1 as being in DNA server 103, but these component modules 105, 107, 109, 111 may also be separate computing devices on computer network 198. The computer component modules 105, 107, 109, 111 are discussed further below with reference to the process flow diagrams of FIG. 4.

Process Flow

Referring first to FIG. 4A, the process starts at step 401 as a user requests a file or other piece of content. The user request may be initiated by clicking on a content Web page that contains a download now button for a piece of content. The click action then executes a content link builder that constructs the URL for the file that corresponds to the content listed. This construct may be accomplished, for example, by sending an HTTP GET to the DNA foundation module 105. The authorization token may be included in the HTTP header. In step 403, DNA broker module 205 sends an encryption string to client 101 with DNA helper module 125 in the string. In step 405, client 101 receives the encryption string and sends acknowledgment back to DNA broker module 205.

The content delivered may be different based on the subscription status of the downloading user. Logic for the content link builder may be embedded in DNA foundation module 105 to determine which content to download. The URL may refer to a path to one of the virtual Atlas stacks 160a, 160b, 160c, 160d, and the path and filename may refer to the specific file in question. As outlined above, the Atlas stacks 160a, 160b, 160c, 160d may include four stacked arrays of servers, such as two on the west coast and two on the east coast. Each pair may include a rate limited basic stack and an unlimited subscriber stack. Further there is no limit on the total number of connections for each stack. The effects of these configurations settings are that under certain conditions there is much higher availability for paid subscribers than there is for nonsubscribers.

In step 407, DNA broker module 205 hands authorization to DNA resource manager module 207, and in step 409 DNA broker module 205 installs DNA helper module 125 on the client 101.

Continuing with a method in accordance with the present invention, in FIG. 4B, DNA resource manager module 207 takes the authorization received from DNA broker module. In step 411, DNA resource manager 207 determines a user profile and permission level. If DNA resource manager module 207 determines that the authorization is not valid in step 415, DNA resource manager 207 sends an error message to the client in step 419. For example, the error message may be an HTTP 403 error message. The process then stops in step 423. However, if the DNA resource manager 207 determines that the authorization is valid in step 415, then in step 427, DNA resource manager 207 of the DNA foundation module 105 prioritizes delivery of the requested content. DNA resource manager 207 establishes a delivery file path by allocating bandwidth and balancing loads currently on the system 100.

In step 435, DNA resource manager 207 determines if the established file path has sufficient resources to service the user request. If sufficient resources are available to service the user request, in step 439 DNA resource manager 207 forwards the requested data file to the scheduler module 233 and to delivery module 234 for delivery and file transfer to the user 101. As the transfer is performed, in step 443 the statistics collector module 219 monitors the transfer, the file, and the file systems of the server 103 and the client 101 and reports delivery statistics and metrics. These measures may be stored in DNA statistics database 221 or another suitable database.

However, if sufficient resources are determined to be not available to service the user request in step 435, DNA resource manager 207 forwards the user request to the queuing module 244, and the request enters a delivery queue in step 447.

Continuing the process in FIG. 4C, when the user request enters a delivery queue, the user is presented with delivery options in step 451. These options may include offers to upgrade their user profile to improve their position in the delivery queue as well as other options that serve to dedicate additional resources to the queuing module 244 based upon the profile and permission level of the user. The additional resources that may be made available to the queuing module for delivery of the data file to service the user request may be prioritized based upon the confirmed permission level of the user. If, in step 455, the user chooses to upgrade their user profile to improve their position in the delivery queue, the user's position in the queue is updated in step 459, and the delivery of the requested file is re-prioritized using rescheduling module 238 as the process returns to step 427.

However, if the user chooses not to upgrade their profile in step 455, the process continues to step 463 and display ads, up-sell promotions, and other sponsored activities are served to the client 101 via advertising module 243 and sponsor module 239. The user is again offered the opportunity to upgrade their profile to improve their position in the delivery queue in step 467. If the user chooses to upgrade their profile in step 467, the user's position in the delivery queue is updated in step 459, and the delivery of the requested file is re-prioritized using rescheduling module 238 as the process returns to step 427.

If the user chooses not to upgrade their profile in step 467, the process continues to step 471, and the DNA resource manager module 207 determines if the download delivery queue is full. If DNA resource manager module 207 determines that the delivery queue is full, in step 475 an error message is sent to the user, such as an HTTP 503 error message. Once the error message is sent, in step 479 the process stops.

If DNA resource manager module 207 determines that the delivery queue is not full in step 471, an attempt to service the request using multiple hosts is made in step 483. This service attempt may include streaming the file in chunks from multiple hosts to the client as described above. A delivery file path is established in step 487, and bandwidth is allocated and loads balanced as described above.

Proceeding to FIG. 4D, the process continues in step 491 as the DNA resource manager module 207 facilitates a client connection to multiple hosts to access and receive the requested data file in chunks. In step 495, the chunks of data are delivered using additional available resources, such as the multiple hosts, and the status of the transfer is updated as is the download queue. The DNA broker module 205 monitors the transfer as it proceeds. If the file transfer completes without delivery interruption in step 499, the process proceeds to step 503 and the delivered chunks are stored and then assembled into the complete file (content) on the client 101 upon completion of the transfer. The successful transfer is reported to DNA foundation module 105. As the transfer is performed and then completed, in step 507 the statistics collector module 219 monitors the transfer, the file, and the file systems of the server 103 and the client 101 and reports delivery statistics and metrics. These measures may be stored in DNA statistics database 221 or another suitable database. Once the statistics are collected and reported, the file delivery is complete in step 511.

As DNA broker module 205 monitors the transfer, it may determine that the file transfer was interrupted in step 499. If the file transfer is interrupted, in step 515 the DNA helper module 125 reports the interruption to the DNA statistics collector module 219. Once the report is made, the full chunks that were delivered are stored and labeled in step 519. The successfully delivered chunks are reported to DNA broker 205, and any partially-delivered data chunks are discarded by DNA helper module 125. If the DNA foundation module 105 determines that a retry is to take place in step 523, the successfully delivered chunks of data are marked in step 535 to avoid re-delivery attempts of these data chunks, and the process returns to step 491 where the client is connected to multiple hosts to access and receive the missing data chunks.

If the DNA foundation module 105 determines that no retry is to be attempted, the process continues to step 527 where the incomplete transfer is reported to the client 101 and to the DNA foundation module 105 by statistics collector module 219. These measures may also be stored in DNA statistics database 221 or another suitable database. Once the statistics are collected and reported, the interrupted file delivery is complete in step 531.

Delivery throughput may be erratic and difficult to predict with download peaks corresponding to yearly events such as key download offerings by a variety of content providers. Major downloads can drive download utilization three to five times higher than the average base utilization. The Atlas stacks 160a, 160b, 160c, 160d are designed to handle these peak utilization events rather than merely the baseline utilization rates.

By using third party content delivery networks 170a, 170b, 170c, users will realize improved consistency and quality of service, regardless of the level of service. For example, premium subscribers may be routed to the CDNs 170a, 170b, 170c when the number of premium user connections exceeds what may be serviced directly by the Atlas stacks 160a, 160b, 160c, 160d and when users experience poor connectivity to the Atlas stacks 160a, 160b, 160c, 160d. The system and method of the present invention uses active routing to load balance the Atlas Stacks 160a, 160b, 160c, 160d and utilize peer to peer distributed download strategies to decrease demand on the Atlas stacks 160a, 160b, 160c, 160d during peak utilization. The net effect of these measures is that the system and method of the present invention produces a more robust and consistent download service while decreasing the costs of operations and minimizing expansion costs for the Atlas stacks 160a, 160b, 160c, 160d. This more granular and consistent service level for users also provides flexible means of management of incentives for service level upgrades.

The devices and subsystems of the exemplary embodiments of FIGS. 1-4 are for exemplary purposes, as many variations of the specific hardware used to implement the exemplary embodiments are possible, as will be appreciated by those skilled in the relevant arts. For example, the functionality of one or more of the devices and subsystems of the exemplary embodiments of FIGS. 1-4 can be implemented via one or more programmed computer systems or devices.

To implement such variations as well as other variations, a single computer system can be programmed to perform the special purpose functions of one or more of the devices and subsystems of the exemplary embodiments of FIGS. 1-4. On the other hand, two or more programmed computer systems or devices can be substituted for any one of the devices and subsystems of the exemplary embodiments of FIGS. 1-4. Accordingly, principles and advantages of distributed processing, such as redundancy, replication, and the like, also can be implemented, as desired, to increase the robustness and performance of the devices and subsystems of the exemplary embodiments of FIGS. 1-4.

The devices and subsystems of the exemplary embodiments of FIGS. 1-4 can store information relating to various processes described herein. This information can be stored in one or more memories, such as a hard disk, optical disk, magneto-optical disk, RAM, and the like, of the devices and subsystems of the exemplary embodiments of FIGS. 1-4. One or more databases of the devices and subsystems of the exemplary embodiments of FIGS. 1-4 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-4 can include appropriate data structures for storing data collected and/or generated by the processes of the devices and subsystems of the exemplary embodiments of FIGS. 1-4 in one or more databases thereof.

All or a portion of the devices and subsystems of the exemplary embodiments of FIGS. 1-6 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments of FIGS. 1-4 can be implemented on the World Wide Web. In addition, the devices and subsystems of the exemplary embodiments of FIGS. 1-4 can be implemented by the preparation of application-specific integrated circuits or by interconnecting an appropriate network of conventional component circuits, as will be appreciated by those skilled in the electrical arts. Thus, the exemplary embodiments are not limited to any specific combination of hardware circuitry and/or software.

As stated above, the devices and subsystems of the exemplary embodiments of FIGS. 1-4 can include computer readable media or memories for holding instructions programmed according to the teachings of the present invention and for holding data structures, tables, records, and/or other data described herein. Computer readable media can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A computer-implemented method for managing delivery of data files, the method comprising:
receiving a user request for a data file;
determining a user profile based upon the received user request;
establishing a file path for delivery of the requested data file based upon the user profile;
prioritizing delivery of the requested data file based upon the user profile; and
delivering the requested data file using the established file path and the prioritization determination.

2. The computer-implemented method for managing delivery of data files of claim 1, wherein the user profile includes a permission level of the user.

3. The computer-implemented method for managing delivery of data files of claim 2 further comprising:
confirming the permission level of the user based upon the determined user profile;
establishing the file path for delivery of the requested data file based upon the confirmed permission level of the user; and
re-prioritizing delivery of the requested data file based upon the confirmed permission level of the user.

4. The computer-implemented method for managing delivery of data files of claim 3 further comprising:
determining if a sponsored upgrade applies based upon the determined user profile;
upgrading the permission level based the sponsorship upgrade;
establishing an upgraded file path for delivery of the requested data file based upon the upgraded permission level of the user; and
re-prioritizing delivery of the requested data file based upon the upgraded permission level of the user.

5. The computer-implemented method for managing delivery of data files of claim 3 further comprising:
determining if the established file path has sufficient resources to service the user request; and
if sufficient resources are available to service the user request, delivering the requested data file to the user; and
if sufficient resources are not available to service the user request, entering the user request into a queue, wherein additional resources are made available to the queue based upon the permission level of the user.

6. The computer-implemented method for managing delivery of data files of claim 5, wherein the additional resources made available to the queue for delivery of the data file to service the user request are prioritized based upon the confirmed permission level of the user.

7. The computer-implemented method for managing delivery of data files of claim 6, wherein the queue in which the user request is entered is determined based upon the permission level of the user.

8. The computer-implemented method for managing delivery of data files of claim 5, wherein, if sufficient resources are not available to service the user request, the additional resources made available to the queue include connecting to multiple hosts to access and receive the requested data file in chunks.

9. The computer-implemented method for managing delivery of data files of claim 8, wherein, if the delivery of the chunks of the data file is interrupted, the method resumes the delivery of the chunks at the point the interruption occurred, thereby eliminating the need to re-deliver the entire data file.

10. The computer-implemented method for managing delivery of data files of claim 5, wherein, if sufficient resources are not available to service the user request, the additional resources made available to the queue include additional bandwidth resources to increase the speed of the delivery of the requested data file.

11. The computer-implemented method for managing delivery of data files of claim 10, wherein the additional bandwidth resources to increase the speed of the delivery of the requested data file are allocated based upon the permission level of the user.

12. The computer-implemented method for managing delivery of data files of claim 5, wherein the sufficient resources available to service the user request are scaled based upon predictions related to demand for the requested data file.

13. The computer-implemented method for managing delivery of data files of claim 12, wherein the predictions related to demand include predictions based upon at least one of time of day, day of the week, or week of the year of the request.

14. The computer-implemented method for managing delivery of data files of claim 12, wherein the predictions related to demand include predictions based upon at least one of popularity of the requested file, subject matter of the requested file, geographic location from which the request is initiated, or demographic data of anticipated users.

15. The computer-implemented method for managing delivery of data files of claim 3, further comprising reporting statistics regarding the delivery of data files for performance analysis and business reporting.

16. The computer-implemented method for managing delivery of data files of claim 5, further comprising a user modifying their permission level to alter the position of the user request in the queue.

17. The computer-implemented method for managing delivery of data files of claim 5, further comprising displaying the queue and a status of the user requested data file delivery.

18. The computer-implemented method for managing delivery of data files of claim 1, including displaying a list of available data files that a user may request for delivery.

19. The computer-implemented method for managing delivery of data files of claim 3, further comprising displaying at least one of advertising messages or up-sell promotions to the user based upon the confirmed permission level of the user.

20. A computer system for managing delivery of data files, the system comprising:
a delivery network architecture foundation server, wherein the delivery network architecture foundation server includes:
a receiving module that receives a user request for a data file;
a determination module that determines a user profile based upon the received user request;
a pathmaker module that establishes a file path for delivery of the requested data file based upon the user profile;
a scheduler module that prioritizes delivery of the requested data file based upon the user profile; and
a delivery module that delivers the requested data file using the established file path and the prioritization determination.

21. The computer system for managing delivery of data files of claim 20 further comprising a delivery network architecture database that stores the requested data file for delivery to the user by the delivery network architecture server.

22. The computer system for managing delivery of data files of claim 20, wherein the user profile includes a permission level of the user.

23. The computer system for managing delivery of data files of claim 22 further comprising:
a permission slip device that confirms the permission level of the user based upon the determined user profile;
field trip device that establishes the file path for delivery of the requested data file based upon the confirmed permission level of the user; and
a rescheduling module that re-prioritizes delivery of the requested data file based upon the confirmed permission level of the user.

24. The computer system for managing delivery of data files of claim 23 further comprising:
a sponsor module that determines if a sponsored upgrade applies based upon the determined user profile;
an upgrade module that upgrades the permission level based the sponsorship upgrade;
an express lane device that establishes an upgraded file path for delivery of the requested data file based upon the upgraded permission level of the user; and
a preferred rescheduling module that re-prioritizes delivery of the requested data file based upon the upgraded permission level of the user.

25. The computer system for managing delivery of data files of claim 23 further comprising:
a resource manager that determines if the established file path has sufficient resources to service the user request, and if sufficient resources are available to service the user request, forwards the requested data file to the delivery module for delivery to the user, and if sufficient resources are not available to service the user request, enters the user request into a queuing module, wherein additional resources are made available to the queuing module based upon the permission level of the user.

26. The computer system for managing delivery of data files of claim 25, wherein the additional resources made available to the queuing module for delivery of the data file to service the user request are prioritized based upon the confirmed permission level of the user.

27. The computer system for managing delivery of data files of claim 26, wherein the queuing module in which the user request is entered is determined based upon the permission level of the user.

28. The computer system for managing delivery of data files of claim 25 further comprising multiple hosts, wherein if sufficient resources are not available to service the user request, the additional resources made available to the queuing module include the multiple hosts to access and receive the requested data file in chunks.

29. The computer system for managing delivery of data files of claim 25 further comprising additional bandwidth resources, wherein if sufficient resources are not available to service the user request, the additional resources made available to the queuing module include the additional bandwidth resources to increase the speed of the delivery of the requested data file.

30. The computer system for managing delivery of data files of claim 25, wherein the sufficient resources available to service the user request are scaled based upon predictions related to demand for the requested data file.

31. The computer system for managing delivery of data files of claim 23, further comprising a delivery network architecture statistics collector that collects and reports statistics from users regarding the delivery of data files for performance analysis and business reporting.

32. The computer system for managing delivery of data files of claim 31, wherein the collected and reported statistics include at least one of number of downloads, average download times by permission level, bandwidth by permission level, number of connection failures, and queue lengths by permission level.

33. The computer system for managing delivery of data files of claim 20 further comprising a display module that displays a list of available data files that a user may request for delivery.

34. The computer system for managing delivery of data files of claim 23 further comprising an advertising module that displays at least one of advertising messages or up-sell promotions to the user based upon the confirmed permission level of the user.

35. The computer system for managing delivery of data files of claim 20, further comprising a delivery network architecture helper module installed on a client to initiate delivery of the requested data file and provide status of the delivery.

36. The computer system for managing delivery of data files of claim 35, wherein the delivery network architecture helper module includes a client management library to store and assemble the requested data file on a client file system.

37. The computer system for managing delivery of data files of claim 36, wherein the stored and assembled data file is stored in file chunks as the requested data file is delivered to the client.

38. The computer system for managing delivery of data files of claim 37, wherein the stored and assembled data file stored in chunks is segmented using range retrieval requests.

39. The computer system for managing delivery of data files of claim 38, wherein the range retrieval requests resume delivery of the chunks of the segmented data file if the delivery is interrupted.

40. The computer system for managing delivery of data files of claim 39, wherein the range retrieval request discards the chunk of the segmented data file that was being delivered when the delivery was interrupted, retains previously delivered chunks, and resumes delivery of remaining chunks of the segmented data file thereby eliminating the need to re-deliver the entire data file when delivery is interrupted.

41. The computer system for managing delivery of data files of claim 20, wherein the delivery network architecture foundation server includes a delivery network architecture broker to monitor availability of the system to serve new clients.

42. The computer system for managing delivery of data files of claim 41, wherein the delivery network architecture foundation server includes a delivery network architecture resource manager to allocate bandwidth for client content delivery requests based upon a permission level of the client.

43. The computer system for managing delivery of data files of claim 42, wherein the new clients are served by the delivery network architecture resource manager.

44. The computer system for managing delivery of data files of claim 20, wherein the delivery network architecture foundation server includes a delivery network architecture metadata interface to abstract sources for file download locations.

45. The computer system for managing delivery of data files of claim 44, wherein the delivery network architecture foundation server includes a delivery network architecture content interface that manages connections and queries to the delivery network architecture metadata interface in response to a query for a list of file download locations.

46. The computer system for managing delivery of data files of claim 20, wherein the delivery network architecture foundation server includes a user registration service interface that abstracts and centralizes user registration service comparisons to validate user profiles.
